(19) United States
(12) Patent Application Publication
(10) Pub. No.: US 2011/0198462 A1
(43) Pub. Date: Aug. 18, 2011

(54) Handi-Hanger

(76) Inventor: Bob Lee Pell, Enumclaw, WA (US)

(21) Appl. No.: 13/020,214

(22) Filed: Feb. 3, 2011

Related U.S. Application Data
(60) Provisional application No. 61/304,768, filed on Feb. 15, 2010.

(51) Int. Cl. F16B 47/00; F16M 13/00

(52) U.S. Cl. 248/206.2; 248/309.1

(57) ABSTRACT

An architecture is presented that provides an easily moveable and repositionable hanger. The hanger permits a user to manipulate and reposition the various parts of the hanger to reconfigure the hanger into a desired architecture. The hanger is rotatable relative to its base, and its individual arms are also individually rotatable relative to one another. The hanger can be removably attached to a multitude of different surfaces and is useful for hanging or storing many different types of articles.

### CROSS-REFERENCE

This application claims priority from Provisional Patent Application Ser. No. 61/304,768 filed Feb. 15, 2010.

### BACKGROUND

Often times when washing dishes, cooking utensils, pots and pans and the like individuals working in or around a kitchen will lay a wet or damp sponge or wash cloth on a countertop or in a sink area where it may retain moisture and become a breeding ground for bacteria. Likewise, individuals that are cooking will often times lay cooking utensils on a countertop or sink area, which can create a mess and may also be unsanitary. Other individuals may leave wet or damp washcloths or towels in piles on a floor or other surface in a bathroom, kitchen or washroom, which permits the article to retain moisture, which is undesirable and prevents the article from properly drying. However, there is not always a convenient location to hang or store the aforementioned items and other articles.

One solution that is known in the art is to attach a hanger or other structure such as a hook to a wall or other surface to accommodate the hanging of towels, sponges, cooking utensils and the like. However, such prior art hooks are typically not repositionable or adjustable, and can damage the structure said hooks are attached to when removed, which is undesirable and can lead to costly and time consuming repairs.

Other free standing hangers, such as hat or coat racks are oftentimes bulky, difficult to move, and consume too much space. Said racks are also typically not repositionable or adjustable in height and are not well suited for the kitchen, bathroom and washroom environments, which are typically relatively small confined spaces.

Therefore, a need exists for a hanger for hanging or storing items that is repositionable, adjustable, and does not consume too much space. The proposed invention allows for a hanger that can accommodate a number of different items at the same time and of potentially varying shapes and sizes. The proposed hanger is durable, easy to use and relatively inexpensive to manufacture.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises an easily moveable and repositionable hanger for hanging and/or storing a multitude of different articles. The hanger of the present invention preferably comprises a base, a base arm, at least one block with at least one opening therein for receipt of said base arm, and at least one additional arm also attached to said block. Specifically, the hanger of the present invention permits a user to manipulate and reposition the various parts of the hanger to configure a hanger of desired architecture, and to rotate the hanger 360 degrees within its base, and to rotate its individuals arms 360 degrees within an opening in the block.

Furthermore in the preferred embodiment of the present invention, the base of the hanger further comprises a suction cup device and a handle operatively attached thereto. The handle assists the user in engaging/disengaging the suction cup device from a surface. Handle further comprises an opening therein for receipt of the base arm or, alternatively, the additional arm 40.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of one embodiment of the hanger in accordance with the disclosed architecture.

FIG. 2 illustrates a cross-sectional elevational view of the base of the hanger embodiment depicted in FIG. 1 in an engaged position.

FIG. 4 illustrates an elevational view of the base depicted in FIG. 1 in a disengaged position.

FIG. 5 illustrates a perspective view of an embodiment of the hanger in accordance with the disclosed architecture in which the hanger arms are of different shapes and are positioned at various heights in relation to the base and in various directions, one hanger arm supporting a cleaning utensil.

FIG. 6 illustrates a perspective exploded view of a block and its fasteners.

FIG. 7 illustrates a perspective view of another embodiment of the hanger in accordance with the disclosed architecture including a second block and a tray.

FIG. 8 illustrates a perspective view of yet another embodiment of the hanger in accordance with the disclosed architecture including a single base arm.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

Typically, most prior art hangers are static devices, such that the individual components of said hangers cannot be manipulated or repositioned relative to one another or to the base, which limits the usefulness of the hanger to the user. Additionally, most hangers of the prior art (e.g., a hook mounted to a wall) are fixed devices, such that the hanger cannot be easily moved to a new location (e.g., from a bathroom to a kitchen).

Accordingly, the disclosed hanger allows the user to manipulate the hanger in a myriad of different ways to accommodate the user's preference and to accommodate the particular article being hung or stored thereon. More specifically, the disclosed hanger can be rotated 360 degrees within its base, and its individual arms can also be rotated 360 degrees and extended or shortened, relative to the base, to permit a nearly unlimited number of different configurations to accommodate user preference. Further, the disclosed hanger can also be easily repositioned and removably attached to various surfaces including, without limitation, tables, counter-tops, floors, shelves and the like.

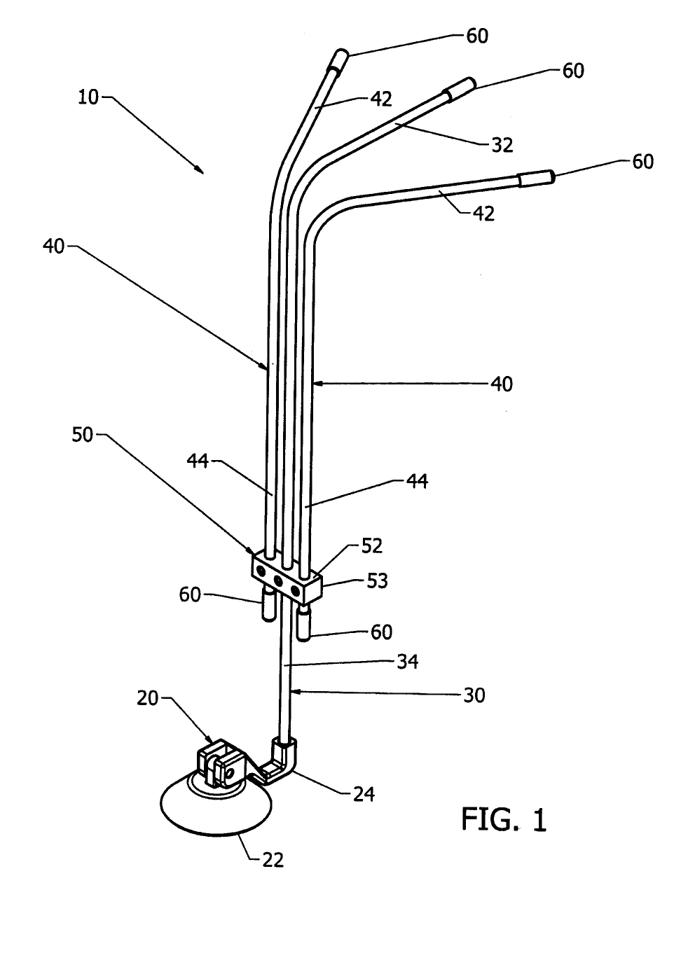

Referring initially to the drawings, FIG. 1 illustrates a preferred embodiment of hanger 10. Hanger 10 is preferably comprised of a base 20, a base arm 30, at least one arm 40, and at least one block 50. Unless otherwise stated herein, all components of hanger 10 are preferably made of stainless steel, although it is contemplated that other suitable materials, such as wood, plastic and the like could also be used without affecting the overall concept of the invention.

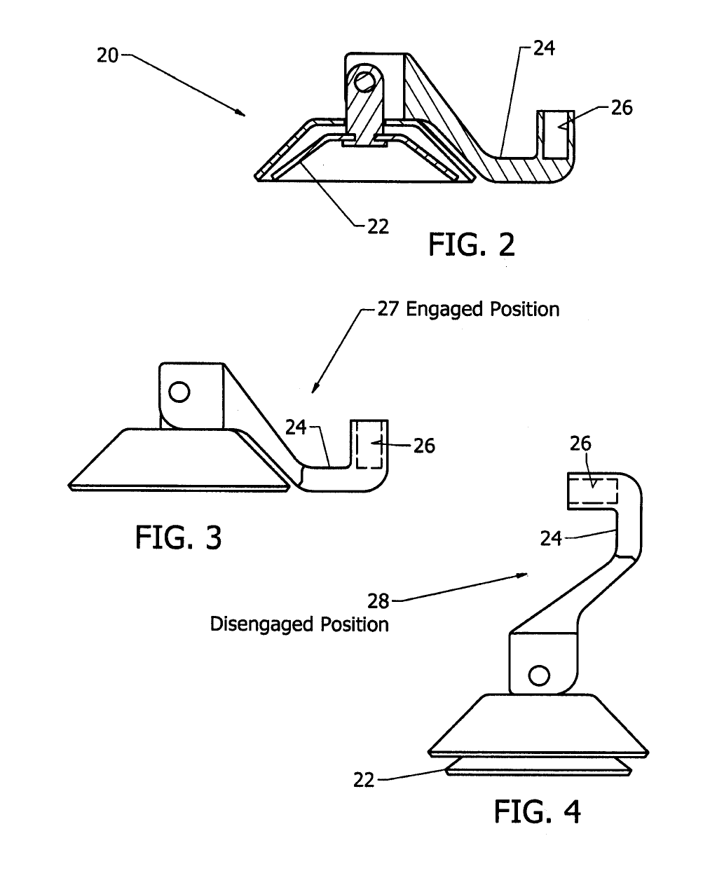

As illustrated in FIG. 2, base 20 is further comprised of a suction cup device 22 and a handle 24 operatively attached thereto to assist the user to engage/disengage suction cup device 22 from a surface (not shown). Suction cup device 22 can be any suction cup known in the prior art, and preferably a locking suction cup, and is readily available at most hardware stores. Handle 24 is preferably constructed of plastic, though other suitable materials such as stainless steel, wood and the like can also be used without affecting the overall concept of the invention. Handle 24 further comprises an opening 26 therein for receipt of base arm 30 or, alternatively, arm 40, as shown in FIG. 1. FIG. 3 illustrates suction cup device 22 and handle 24 in the engaged position 27, such that suction cup device 22 is removably attached to a surface and handle 24 is in proper position for receipt of one of base arm 30 or, alternatively, arm 40 in opening 26. FIG. 4 illustrates handle 24 in a disengaged position 28.

As best illustrated in FIG. 1, base arm 30 is preferably an elongated stainless steel rod of desired length with a generally circular cross-section that can be inserted into opening 26 of handle 24 to removably connect base arm 30 to base 20. Base arm 30 can also include a curvilinear or other shaped upper portion 32 and a lower portion 34 for removably connecting base arm 30 to base 20. It is also contemplated that upper portion 32 can be relatively linear without affecting the overall concept of the present invention.

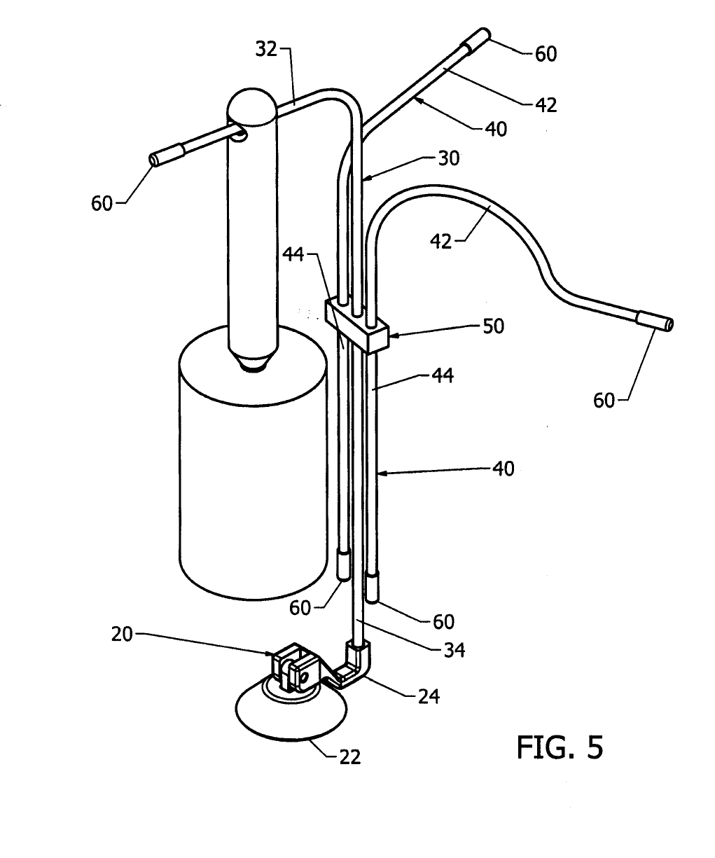

Upper portion 32 is useful for hanging or otherwise storing items such as cleaning implements, cooking utensils, towels, wash cloths and the like as illustrated in FIG. 5. Due to the generally circular cross-section of base arm 30, it is possible to rotate base arm 30 360 degrees within opening 26 of handle 24 to position upper portion 32 of base arm 30 in any desired direction.

Base arm 30 is preferably between 6 inches and 36 inches in length with a diameter of between ⅛ of an inch and 1 inch, although other desired lengths and diameters can be used without affecting the overall concept of the invention provided that opening 26 in handle 24 is sized accordingly to receive base arm 30 and permit base arm 30 to rotate therein.

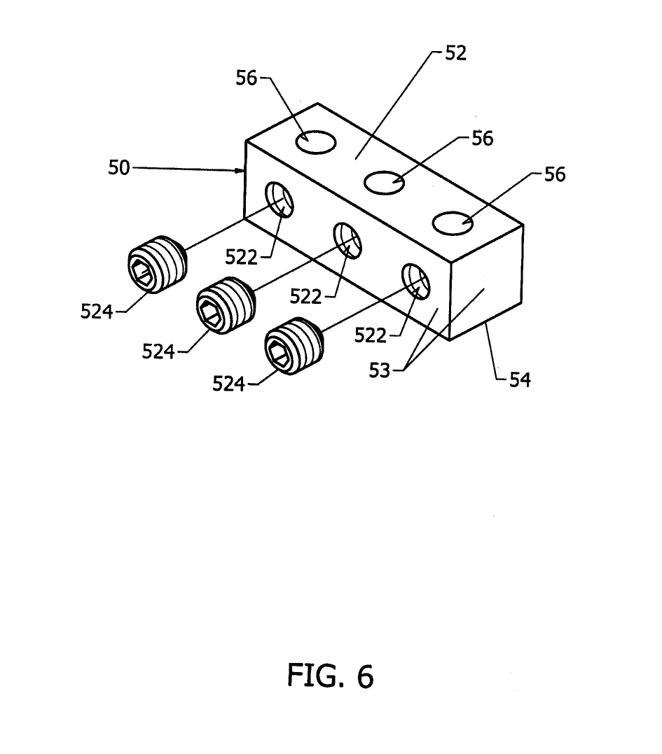

In a preferred embodiment of hanger 10, block 50 is a generally rectangular stainless steel block with an upper surface 52, side surfaces 53 and a lower surface 54. Block 50 is further comprised of at least one continuous opening 56 therethrough from upper surface 52 to lower surface 54 as shown in FIG. 6 for receipt of base arm 30 or, alternatively, arm 40. Moreover, block 50 preferably has multiple openings 56 therethrough to accommodate base arm 30 and a plurality of arms 40 as also depicted in FIG. 6.

In order to secure block 50 to base arm 30 and/or arm(s) 40 at a particular location along their respective lengths, at least one of said side surfaces 53 is comprised of at least one opening 522 therein as illustrated in FIG. 5. Opening 522 is preferably partially threaded for receipt of a set screw or other fastener 524 for coming into contact with base arm 30 or arm 40 to removably secure block 50 thereto at a desired position along base arm 30 and/or arms 40. Moreover, at least one of side surfaces 53 preferably has multiple threaded partial openings 522 therein, each capable of receiving a fastener 524 for securing block 50 to base arm 30 or arm 40.

Similar to base arm 30, arm 40 is preferably an elongated stainless steel rod of desired length with a generally circular cross-section that can be inserted into opening 56 of block 50 to removably connect arm 40 to hanger 10. Arm 40 can also include a non-linear upper portion 42 and a non-linear lower portion 44. It is also contemplated that upper portion 42 and/or lower portion 44 can be relatively linear without affecting the overall concept of the present invention.

Upper portion 42 and lower portion 44 can be useful for hanging or otherwise storing a number of different items as illustrated in FIG. 5. Due to the generally circular cross-section of arm 40, it is possible to rotate arm 40 360 degrees within opening 56 of block 50 to position upper portion 42 and lower portion 44 in any desired direction.

Arm 40 is preferably between 6 inches and 36 inches in length with a diameter of between ⅛ of an inch and 1 inch, although other desired lengths and diameters can be used without affecting the overall concept of the invention provided that openings 56 in block 50 are sized accordingly to receive base arm 30 and arm 40. Rubber or plastic caps 60 can also be installed on the upper portion 32 of base arm 30 and upper and lower portions 42, 44 of arms 40 for safety or aesthetic purposes.

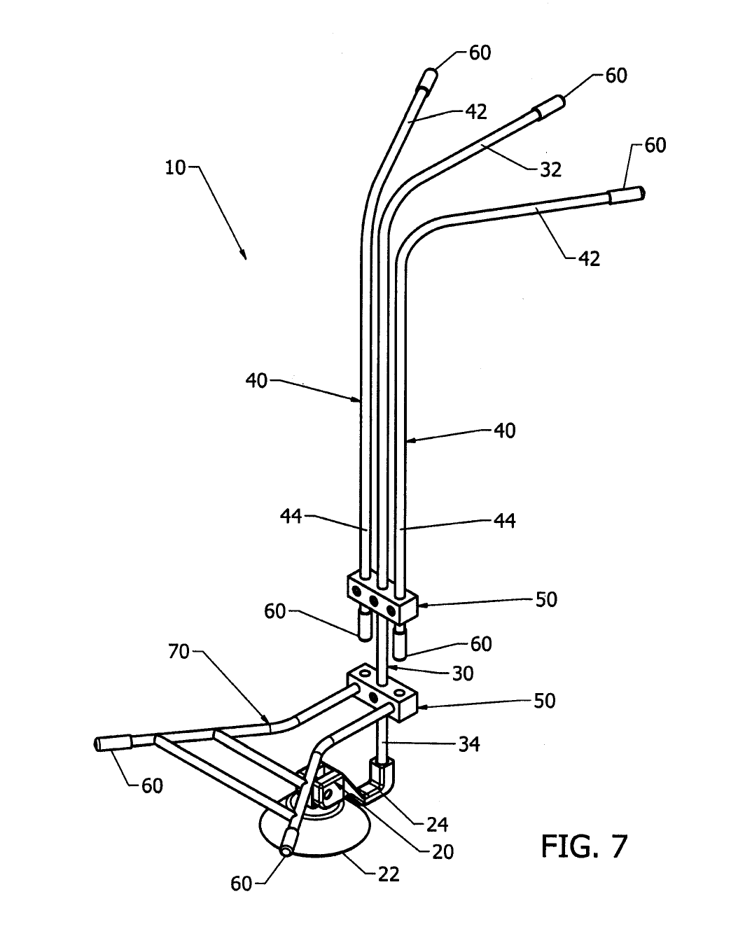

In a further embodiment of the present invention, an additional block 50 can be removably installed along one or more of base arm 30 and/or arms 40 in the same manner described herein for first block 50. Additional block 50 can be useful for attaching other useful devices such as tray 70, or other useful articles, to hanger 10, as illustrated in FIG. 7.

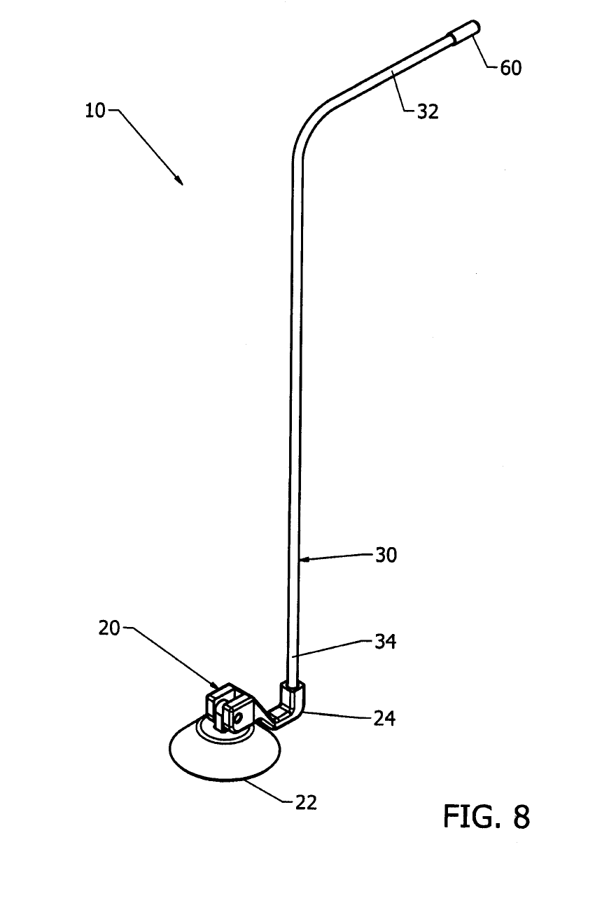

A further embodiment of the present invention is depicted in FIG. 8 with a single base arm 30.

Having now described a number of different embodiments of hanger 10, its operation and usefulness will now be further described. To utilize hanger 10 of the present invention in the embodiment illustrated in FIG. 1, the user (not shown) will attach suction cup device 22 of base 20 to a desired surface (also not shown) by gently pressing suction cup device 22 against said surface and rotating handle 24 into engaged position 24. User can then insert lower portion 34 of base arm 30 into opening 26 of handle 24 and hanger 10 is ready for use.

Additionally, base arm 30 can be rotated 360 degrees within opening 26 to position upper portion 32 in any desired direction. Further, block 50 can be positioned at any desired location along the length of base arm 30 and secured by installing fastener 524 in opening 522 until it contacts base arm 30 and holds block 50 in the desired location along base arm 30. Likewise, arms 40 can also be independently rotated 360 degrees within their respective openings 56 in block 50 as desired by user. The height of arms 40 can also be increased or decreased relative to base 20 to accommodate user preference as shown in FIG. 5. Once the desired positioning of arm 40 is achieved by the user, each of arms 40 can be secured by installing fastener 524 in opening 522 until it contacts arm 40 and secures the same in place.

To remove hanger 10 from a particular surface, the user will simply rotate handle 24 of base 20 into the disengaged position 28 thereby causing suction cup device 22 to be easily removed from the surface.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A hanger comprising:
a base;
a base arm secured to said base; and
at least one block with at least one opening therein for receipt of said base arm.

2. The hanger of claim 1, wherein said at least one block can be removably positioned along said base arm.

3. The hanger of claim 1 wherein said base further comprises a suction cup device and a handle.

4. The hanger of claim 3 wherein said handle comprises an opening therein for receipt of said base arm.

5. The hanger of claim 1 further comprising a second block for attachment of a tray.

6. The hanger of claim 3 wherein said handle is movable between an engaged position and a disengaged position.

7. A hanger comprising:
a base;
a base arm secured to said base;
a block; and
at least one additional arm secured to said block, wherein said block is also secured to said base arm.

8. The hanger of claim 7, wherein said block comprises one opening therein for receipt of said base arm and a second opening therein for receipt of at least one additional arm.

9. The hanger of claim 7, wherein said block can be removably positioned along both of said base arm and said at least one additional arm.

10. The hanger of claim 7 wherein said base further comprises a suction cup device and a handle.

11. The hanger of claim 10 wherein said handle comprises an opening therein for receipt of said base arm.

12. The hanger of claim 7 further comprising a second block and a tray.

13. The hanger of claim 10 wherein said handle is movable between an engaged position and a disengaged position.

14. A hanger comprising:
a suction cup device and a handle operatively connected thereto; and
a base arm attached to said handle.

15. The hanger of claim 14 further comprising a block attached to said base arm.

16. The hanger of claim 15 further comprising a second arm attached to said block.

17. The hanger of claim 15 wherein said block can be removably positioned along said base arm.

18. The hanger of claim 15 wherein a portion of said base arm is non-linear.

19. The hanger of claim 15 further comprising a second block and a tray.

20. The hanger of claim 14 wherein said handle is movable between an engaged position and a disengaged position.
